(19) United States
(12) Patent Application Publication
(10) Pub. No.: US 2009/0252069 A1
(43) Pub. Date: Oct. 8, 2009

(54) POINT-TO-MULTIPOINT NETWORK SYSTEM

(76) Inventors: Ha-Kee Ahn, Gwanak-gu (KR); Cheal-Jin Park, Hwaseong-si (KR)

Correspondence Address: SHERR & VAUGHN, PLLC, 620 HERNDON PARKWAY, SUITE 320, HERNDON, VA, 20170, US

(21) Appl. No.: 12/368,252

(22) Filed: Feb. 9, 2009

(30) Foreign Application Priority Data
Apr. 8, 2008 (KR) 10-2008-0032824

(51) Int. Cl. H04L 5/14; H04M 11/00; H04L 12/28

(52) U.S. Cl. 370/295; 379/93.05; 370/431

(57) ABSTRACT

A point-to-multipoint network system using an in-house telephone line includes a master modem and a plurality of slave modems. The master modem is configured to allocate at least of a plurality of downstream bandwidths (hereinafter, referred to as a first bandwidth) and configured to allocate at least of a plurality of upstream bandwidths (hereinafter, referred to as a second bandwidth). The first bandwidth is capable of including non-contiguous frequency spaces and the second band is capable of including non-contiguous frequency spaces. The plurality of the slave modems are configured to respectively communicate with the master modem through the first and second bandwidths by using the in-house telephone line.

### CROSS-REFERENCE TO RELATED APPLICATION

This application claims the benefit of Korean Patent Application No. 2008-32824, filed Apr. 8, 2008, the contents of which are hereby incorporated herein by reference in their entirety.

### BACKGROUND

1. Technical Field

This application relates to a point-to-multiport network system using a telephone line.

2. Description of Related Art

A rapid development of the Internet brings a change of an infrastructure for a communication network. That is, a user's requirement for high-speed and high quality data service becomes a motive power for the change of the infrastructure. Therefore, building an effective infrastructure of the communication network with low cost is required.

### SUMMARY

In some embodiments, a point-to-multipoint network system using an in-house telephone line includes a master modem and a plurality of slave modems. The master modem is configured to allocate at least of a plurality of downstream bandwidths (hereinafter, referred to as a first bandwidth) and configured to allocate at least of a plurality of upstream bandwidths (hereinafter, referred to as a second bandwidth). The first bandwidth is capable of including non-contiguous frequency spaces and the second band is capable of including non-contiguous frequency spaces. The plurality of the slave modems are configured to respectively communicate with the master modem through the first and second bandwidths by using the in-house telephone line.

The master modem may communicate with each of the plurality of the slave modems through a full duplex FDMA (Frequency Division Multiple Access) and DMT (Discrete Multi-Tone) line coding methods.

The first and second bandwidths may be determined based on a DSL (Digital Subscriber Line) standard when a cross interference occurs due to a cross talk. The first and second bandwidths may be arbitrarily determined when the cross interference does not occur. Each of the first and second bandwidths may be determined based on a FDMA method.

The master modem may communicate with an external device through a separate communication interface.

Each of the plurality of the slave modems may communicate with an external device through a separate communication interface.

In some embodiments, a point-to-multipoint network system using a telephone line from a main distribution frame (MDF) to a house includes a DSLAM (Digital Subscriber Line Access Multiplexer) including a master modem, the master modem configured to allocate at least of a plurality of downstream bandwidths (hereinafter, referred to as a first bandwidth), the first bandwidth being capable of including non-contiguous frequency spaces, and configured to allocate at least of a plurality of upstream bandwidths (hereinafter, referred to as a second bandwidth), the second band being capable of including non-contiguous frequency spaces, the MDF, and a plurality of slave modems configured to respectively communicate with the master modem through the first and second bandwidths, the plurality of the slave modems being coupled to the MDF with a telephone line.

The master modem may communicate with each of the plurality of the slave modems through a full duplex FDMA (Frequency Division Multiple Access) and DMT (Discrete Multi-Tone) line coding methods.

The first and second bandwidths may determined based on a DSL (Digital Subscriber Line) standard when a cross interference occurs due to a cross talk. The first and second bandwidths may arbitrarily determined when the cross interference does not occur. Each of the first and second bandwidths may be determined based on a FDMA method.

The master modem may communicate with an external device through a separate communication interface.

Each of the plurality of the slave modems may communicate with an external device through a separate communication interface.

### BRIEF DESCRIPTION OF THE DRAWINGS

FIG. 1 is a diagram for illustrating a point-to-multipoint network system using an in-house telephone line according to an example embodiment of the described technology.

FIG. 2 is a diagram for illustrating an example embodiment of an in-house network system.

FIG. 3 is a diagram for illustrating a band plan used by a point-to-multipoint network system.

FIG. 4 is a diagram for illustrating another example embodiment of an in-house network system.

FIG. 5 is a diagram for illustrating a point-to-multipoint network system using a telephone line from a main distribution frame (MDF) to a house according to an example embodiment of the described technology.

### DETAILED DESCRIPTION

The technology is described more fully hereinafter with reference to the accompanying drawings, in which example embodiments of the technology are illustrated. The technology may, however, be embodied in many different forms and should not be construed as limited to the example embodiments set forth herein. Rather, these example embodiments are provided to fully enable those of ordinary skill in the art to embody and practice the technology.

Terms used herein are to be understood as described below.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element.

The term “and/or” includes any and all combinations of one or more of the associated listed items. For example, “a first item, a second item and/or a third item” denotes at least one of the first item, the second item and the third item, that is, all the combinations of the first, second and third items including the first item, the second item and the third item each.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements, e.g., “between” versus “directly between” and “adjacent” versus “directly adjacent”, should be interpreted in a like fashion.

As used herein, the singular forms “a”, “an” and “the” are intended to include the plural forms as well, unless the context clearly indicates otherwise. It will be further understood that the terms “comprises”, “comprising”, “includes” and/or “including” when used herein, specify the presence of stated features, integers, steps, operations, elements and/or components, but do not preclude the presence or addition of one or more other features, integers, steps, operations, elements, components and/or groups thereof.

Respective steps described herein may be performed in a different order than that which is explicitly described. In other words, the respective steps may be performed in the same order as described, simultaneously, or in a reverse order.

Unless defined otherwise, all terms used herein have the same meaning as commonly understood by those of skill in the art. Such terms as those defined in a generally used dictionary are to be interpreted to have the meanings equal to the contextual meanings in the relevant field of art, and are not to be interpreted to have ideal or excessively formal meanings unless clearly defined in the present specification.

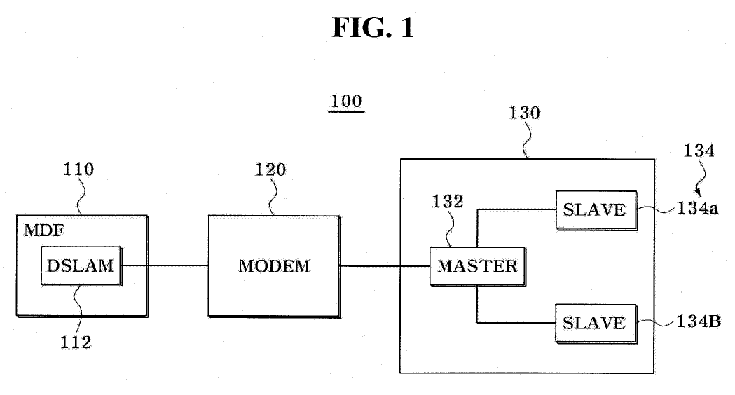

FIG. 1 is a diagram for illustrating a point-to-multipoint network system using an in-house telephone line according to an example embodiment of the described technology.

Referring to FIG. 1, a network system 100 includes an MDF (Main Distribution Framework) 110, a DSLAM (Digital Subscriber Line Access Multiplexer) 112, a modem 120 and an in-house network system 130.

The DSLAM 112 is a multiplexing device which collects data transmitted from or to the modem 120 and transmits the collected data to a backbone network. The DSLAM 112 performs a role of an interface between a subscriber and a service provider, and provides a various network service to the subscriber. In one embodiment, the DSLAM 112 may locate in the MDF 110.

The modem 120 may be coupled to the MDF 110 through a telephone line, a coaxial cable or an optical fiber and modulates a signal transmitted from or to the DSLAM 112. In one embodiment, the modem 120 may be installed in a subscriber's house.

The in-house network system 130 includes a master modem 132 coupled to the modem 120 and a plurality of slave modems 134. The master modem 132 locates in a house and is coupled to the plurality of the slave modems 134 through a telephone line. Because a conventional telephone line may be used, the in-house network system 130 may be built with low cost.

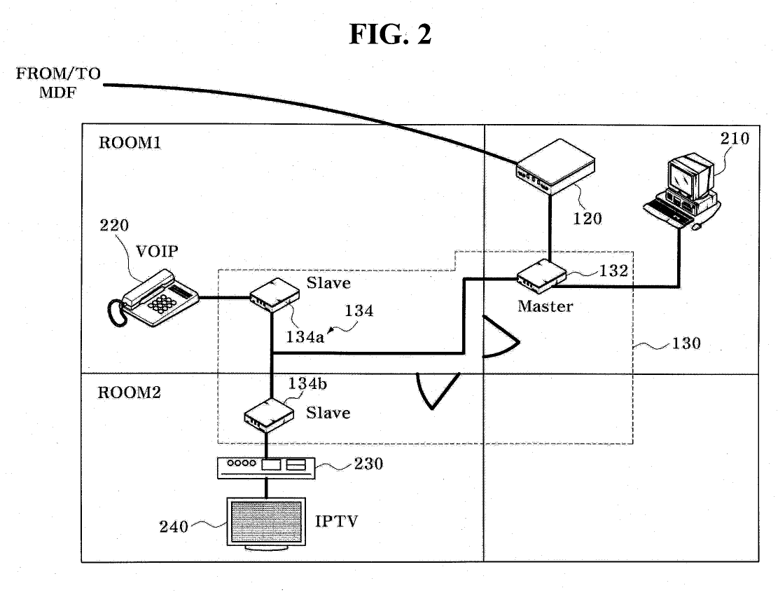

Hereinafter, an operation of the master modem 132 and the plurality of the slave modems 134 will be described with reference to FIGS. 2 through 4.

FIG. 2 is a diagram for illustrating an example embodiment of an in-house network system.

In FIG. 2, the master modem 132 allocates at least of a plurality of downstream bandwidths as downstream service and allocates at least of a plurality of upstream bandwidths as upstream service. The first and/or second bandwidths may include non-contiguous frequency spaces.

In one embodiment, the master modem 132 may communicate with an external device 210 through a separate communication interface. For example, the separate communication interface may correspond to an Ethernet interface.

Each of the first and second slave modems 134a and 134b communicates with the master modem 132 through the first and second bandwidths allocated by the master modem 132. In one embodiment, each of the slave modems 134 may communicate with an external device 220 or 230 through a separate communication interface. For example, the separate communication interface may correspond to an Ethernet interface.

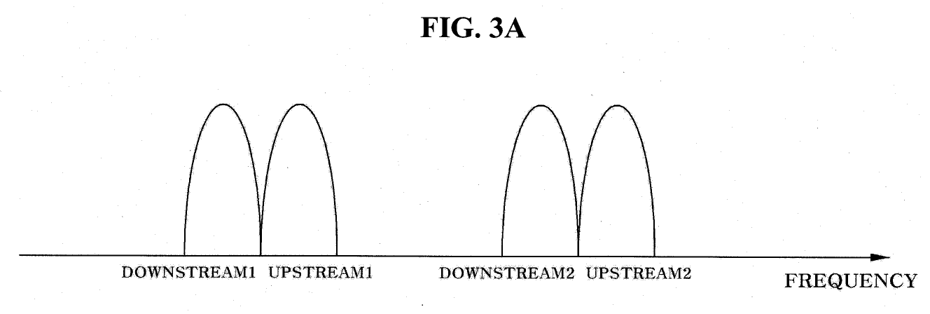

FIG. 3 is a diagram for illustrating a band plan used by a point-to-multipoint network system.

In FIG. 3a, the band plan is configured with a plurality of downstream bandwidths (e.g., DOWNSTREAM1 and DOWNSTREAM2) and a plurality of upstream bandwidths (e.g., UPSTREAM1 and UPSTREAM2).

In one embodiment, each of the first and second bandwidths may be determined based on an FDMA (Frequency Division Multiple Access) method.

In one embodiment, the band plan may be determined based on a DSL (Digital Subscriber Line) standard. For example, the first and second bandwidths may be determined based on a DSL (Digital Subscriber Line) standard when a cross interference occurs due to a cross talk. The cross talk may occur due to a neighbor's telephone line. For another example, the first and second bandwidths may be arbitrarily determined when the cross interference does not occur.

In FIG. 3b, the master modem 132 allocates at least of the first downstream bandwidth 310a (e.g., at least one of DOWNSTREAM1) and at least of the second downstream bandwidth 310b (e.g., at least one of DOWNSTREAM2) as a first downstream bandwidth and the first downstream bandwidth is allocated to the first slave modem 134a. The master modem 132 allocates at least of the first downstream bandwidth 320a (e.g., at least another of DOWNSTREAM1) and at least of the second downstream bandwidth 320b (at least another of UPSTREAM2) as a second downstream bandwidth and the second downstream bandwidth is allocated to the second slave modem 134b.

Also, the master modem 132 allocates at least of the first upstream bandwidth 320a (e.g., at least one of UPSTREAM1) and at least of the second upstream bandwidth 320b (e.g., at least one of UPSTREAM2) as a first upstream bandwidth and the first upstream bandwidth is allocated to the first slave modem 134a. The master modem 132 allocates at least of the first upstream bandwidth 324a (e.g., at least another of UPSTREAM1) and at least of the second upstream bandwidth 340b (e.g., at least another of UPSTREAM2) as a second upstream bandwidth and the second upstream bandwidth is allocated to the second slave modem 134b.

Referring back to FIG. 2, each of the slave modems 134 communicates with the master modem 134 through the first and second bandwidths allocated by the master modem 132. In one embodiment, the in-house network system 130 may communicate by using a full duplex FDMA (Frequency Division Multiple Access) and DMT (Discrete Multi-Tone) line coding methods. That is, the in-house network system 130 may communicate with each of the slave modems 134a and 134b through the full duplex FDMA and DMT line coding methods.

The first slave modem 134a may communicate with a telephone 220 supporting a VOIP (Voice Over IP) and the second slave modem 134b may communicate with a set top box 230 coupled to an IPTV 240.

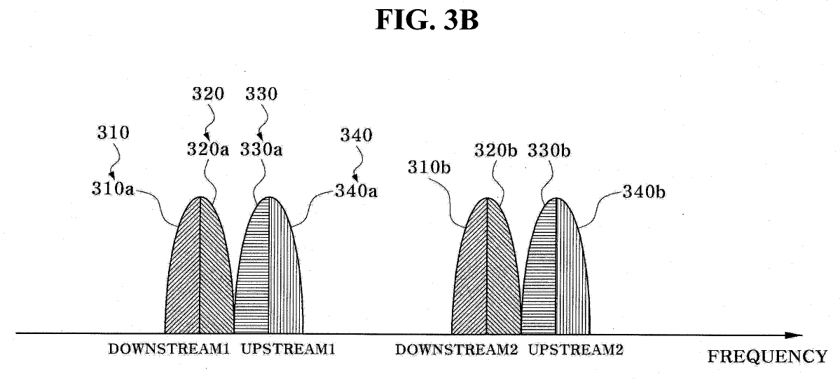

FIG. 4 is a diagram for illustrating another example embodiment of an in-house network system.

Because the in-house network system 130 in FIG. 4 is substantially equal to the in-house network system 130 in FIG. 2, repeated descriptions will be omitted.

The first and second slave modems 134a and 134b may communicate with at least one external device according to a multiple access method.

In FIG. 4, the first slave modem 134a may communicate, through the multiple access method, with a telephone 420 supporting a VOIP (Voice Over IP) and a set top box 430 coupled to an IPTV 440. The second slave modem 134b may communicate, through the multiple access method, with a telephone 450 supporting a VOIP and a set top box 470 coupled to a computer 460 and an IPTV 480.

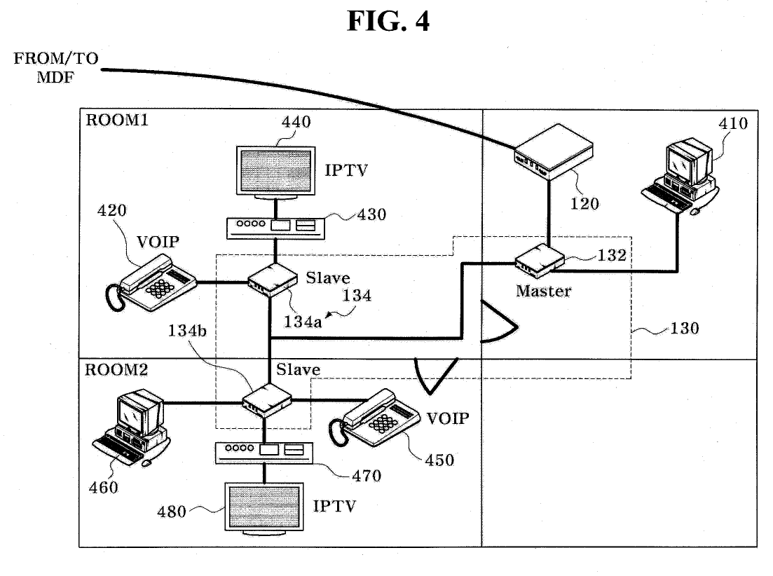

FIG. 5 is a diagram for illustrating a point-to-multipoint network system using a telephone line from a main distribution frame (MDF) to a house according to an example embodiment of the described technology.

Referring to FIG. 5, a point-to-multipoint network system 500 includes a MDF (Main Distribution Frame) 510, a DSLAM (Digital Subscriber Line Access Multiplexer) 512 and an in-house network system 520.

The DSLAM 512 includes a master modem 132 as described in FIG. 1. In one embodiment, the DSLAM 512 may locate in the MDF 110. The master modem 132 allocates at least of a plurality of downstream bandwidths (hereinafter, referred to as a first bandwidth) as downstream service and at least of a plurality of upstream bandwidths (hereinafter, referred to as a second bandwidth) as upstream service. The first and/or second bandwidths may include non-contiguous frequency spaces. Therefore, the point-to-multipoint network system 500 may have an advantage of not including the modem in FIG. 1.

Each of slave modems 522a and 522b is coupled to the MDF 510 through a telephone line, and communicates with the DSLAM 512 through the first and second bandwidths. The first and second bandwidths may be allocated by the master modem 132 in the DSLAM 512. In one embodiment, each of the slave modems 522a and 522b may communicate with an external device through a separate communication interface. For example, the separate communication interface may correspond to an Ethernet interface.

Meanwhile, because the point-to-multipoint network system 500 is substantially equal to the point-to-multipoint network system 100, the technologies described in FIGS. 2 through 4 will be adopted.

The above-described example embodiments may have effects including the following advantages. However, not all of the example embodiments necessarily include all the advantages, and some example embodiments may have additional advantages. Thus, the scope of the present invention is not limited by the described advantages.

A point-to-multipoint network system may use a telephone line to build a network system. In one embodiment, the point-to-multipoint network system may build a network system within a house or an office with low cost.

Also, a point-to-multipoint network system may use a master capable of controlling a plurality of downstream and upstream bandwidths and a plurality of slave modems to build an effective network system. If necessary, the master modem and each of the slave modems may directly communicate a separate external device.

Also, a point-to-multipoint network system may build an effective network system based on a band plan according to a DSL (Digital Subscriber Line) standard. That is, the point-to-multipoint network system may be implemented through a pre-installed telephone line.

It will be apparent to those skilled in the art that various modifications can be made to the above example embodiments without departing from the spirit and scope of the invention defined by the appended claims and their equivalents.

1-14. (canceled)

15. A point-to-multipoint network system using an in-house telephone line, the point-to-multipoint network system comprising:
a master modem configured to allocate a first bandwidth and a second bandwidth, the first bandwidth including at least of a plurality of downstream bandwidths, the second bandwidth including at least of a plurality of upstream bandwidths, wherein the master modem is capable of including non-contiguous frequency spaces in each of the first and second bandwidths; and
a plurality of slave modems configured to communicate with the master modem through the first and second bandwidths by using the in-house telephone line.

16. The point-to-multipoint network system of claim 15, wherein the master modem communicates with each of the plurality of the slave modems using full duplex frequency division multiple access and discrete multi-tone line coding.

17. The point-to-multipoint network system of claim 15, wherein the first and second bandwidths are determined based on a digital subscriber line standard when cross interference occurs due to cross talk.

18. The point-to-multipoint network system of claim 17, wherein the first and second bandwidths are arbitrarily determined when cross interference does not occur.

19. The point-to-multipoint network system of claim 18, wherein each of the first and second bandwidths is determined based on frequency division multiple access.

20. The point-to-multipoint network system of claim 15, wherein the master modem communicates with an external device through a separate communication interface.

21. The point-to-multipoint network system of claim 15, wherein each of the plurality of the slave modems communicates with an external device through a separate communication interface.

22. A point-to-multipoint network system using a telephone line from a main distribution frame to a house, the point-to-multipoint network system comprising:
a digital subscriber line access multiplexer including a master modem, the master modem configured to allocate a first bandwidth and a second bandwidth, the first bandwidth including at least of a plurality of downstream bandwidths, the second bandwidth including at least of a plurality of upstream bandwidths, wherein the master modem is capable of including non-contiguous frequency spaces in each of the first and second bandwidths;
a main distribution frame; and
a plurality of slave modems configured to communicate with the master modem through the first and second bandwidths, the plurality of slave modems being coupled to the main distribution frame with a telephone line.

23. The point-to-multipoint network system of claim 22, wherein the master modem communicates with each of the plurality of slave modems using full duplex frequency division multiple access and discrete multi-tone line coding.

24. The point-to-multipoint network system of claim 22, wherein the first and second bandwidths are determined based on a digital subscriber line standard when cross interference occurs due to cross talk.

25. The point-to-multipoint network system of claim 24, wherein the first and second bandwidths are arbitrarily determined when cross interference does not occur.

26. The point-to-multipoint network system of claim 25, wherein each of the first and second bandwidths is determined based on frequency division multiple access.

27. The point-to-multipoint network system of claim 22, wherein the master modem communicates with an external device through a separate communication interface.

28. The point-to-multipoint network system of claim 22, wherein each of the plurality of slave modems communicates with an external device through a separate communication interface.
